(19) United States
(12) Patent Application Publication
(10) Pub. No.: US 2024/0351527 A1
(43) Pub. Date: Oct. 24, 2024

(54) ROOF RACK AND CARGO BOX ASSEMBLY

(71) Applicant: Bernhard Leitner, Corona, CA (US)

(72) Inventor: Bernhard Leitner, Corona, CA (US)

(21) Appl. No.: 18/640,452

(22) Filed: Apr. 19, 2024

Related U.S. Application Data
(60) Provisional application No. 63/497,639, filed on Apr. 21, 2023.
(60) Provisional application No. 63/518,797, filed on Aug. 10, 2023.

(51) Int. Cl. B60R 9/052; B60R 9/055

(52) U.S. Cl. CPC B60R 9/052; B60R 9/055

(57) ABSTRACT

A system including a rack assembly and/or a cargo container assembly for a vehicle. The rack assembly has first and second side supports configured to be attached to opposite lateral sides of the vehicle. The side supports each define a channel that receives an end of one of a plurality of load bars that extend between the first and second side supports. A clamp is associated with each end of each of the plurality of load bars. A cargo container assembly has a container that defines an interior cargo space. The container includes a wall that defines an aperture. A mount is configured to be attached to the vehicle separately from the container. A coupling is configured to allow the container to be secured to the mount. The coupling includes a first portion located on the mount and a second portion located on the container. A portion of the coupling extends through or passes through the aperture when the container is secured to the mount.

### INCORPORATION BY REFERENCE TO ANY PRIORITY APPLICATIONS

This application claims priority to U.S. Provisional Patent Application No. 63/518,797, filed Aug. 10, 2023, and U.S. Provisional Patent Application No. 63/497,639, filed Apr. 21, 2023, the entireties of which are incorporated herein by reference.

Any and all applications for which a foreign or domestic priority claim is identified in the Application Data Sheet as filed with the present application are hereby incorporated by reference under 37 CFR 1.57.

### BACKGROUND

### Field

The present disclosure relates to vehicle accessories. In particular, the present disclosure relates to a system having a roof rack assembly and/or a cargo container assembly.

### Description of the Related Art

Roof racks and cargo containers for vehicles exist. However, a need still exists for roof racks and/or cargo containers that improve upon the existing systems, or at least provides the public with a useful choice.

### SUMMARY

The systems, methods and devices described herein have innovative aspects, no single one of which is indispensable or solely responsible for their desirable attributes. Without limiting the scope of the claims, some of the advantageous features will now be summarized.

An aspect of the present disclosure involves a rack assembly for a vehicle having a first side support configured to be attached to a first lateral side of the vehicle and a second side support configured to be attached to a second lateral side of the vehicle opposite the first side. The first side support has a first upper wall and a first lower wall defining a first channel having a first opening that faces the second side support. The second side support has a second upper wall and a second lower wall defining a second channel having a second opening that faces the first side support. A plurality of load bars extends between the first side support and the second side support. Each of the plurality of load bars has a first end and a second end. The first end of each of the plurality of load bars is received within the first channel and the second end of each of the plurality of load bars is received within the second channel. A first clamp is associated with the first end of each of the plurality of load bars. The first clamp secures the first end to the first side support. A second clamp is associated with the second end of each of the plurality of load bars. The second clamp secures the second end to the second side support.

In some configurations, each of the first end and the second end of the plurality of load bars comprises at least one channel. Each of the at least one channels is configured to receive a nut and a bolt secures a respective one of the first clamp and the second clamp relative to the load bar.

In some configurations, the at least one channel comprises a pair of channels.

In some configurations, the first clamp engages the first upper wall and the second clamp engages the second upper wall.

In some configurations, an upper surface of the first upper wall comprises a first plurality of grooves and the first clamp comprises a first plurality of teeth that engage the first plurality of grooves, and an upper surface of the second upper wall comprises a second plurality of grooves and the second clamp comprises a second plurality of teeth that engage the second plurality of grooves.

In some configurations, each of the plurality of load bars is infinitely adjustable between a first end and a second end of each of the first channel and the second channel.

In some configurations, the first side support comprises a first rail and at least one first vertical support configured to support the first rail at an elevated position relative to a corresponding surface of the vehicle, and the second side support comprises a second rail and at least one second vertical support configured to support the second rail at an elevated position relative to the corresponding surface of the vehicle.

In some configurations, the first rail defines the first channel and the second rail defines the second channel.

In some configurations, each of the first rail and the second rail is vertically symmetrical.

In some configurations, the first side support comprises a first rail that defines the first channel and the second side support comprises a second rail that defines the second channel, and each of the first side support and the second side support comprises an upward-facing channel and a downward-facing channel.

In some configurations, a container is supported by the plurality of load bars.

In some configurations, the container comprises a side opening.

In some configurations, a mounting plate is attached to one or more of the plurality of load bars, and the container is attached to the mounting plate.

In some configurations, a side wall of the container comprises an aperture and a portion of the mounting plate or an associated latch extends through the aperture.

In some configurations, a seal is located between the mounting plate and the container along a periphery of the aperture.

An aspect of the present disclosure involves a cargo container assembly for a vehicle having a container that defines an interior cargo space. The container includes a wall that defines an aperture. A mount is configured to be attached to the vehicle separately from the container. A coupling is configured to allow the container to be secured to the mount. The coupling includes a first portion located on the mount and a second portion located on the container. A portion of the coupling extends through the aperture when the container is secured to the mount.

In some configurations, the coupling comprises a latch.

In some configurations, the first portion of the latch comprises a catch and the second portion of the latch comprises an arm.

In some configurations, a seal is configured to create a seal between the mount and the container along a periphery of the aperture.

In some configurations, the seal is carried by the mount.

In some configurations, each of the aperture and the seal is circular.

In some configurations, the mount is or comprises at least one mount plate, and the container is secured to the vehicle solely through the at least one mount plate.

In some configurations, the mount is or comprises a mount plate.

In some configurations, the mount plate includes at least one first tab at a first end and at least one second tab at a second end, and the at least one first tab is received within at least one first recess of the container and the at least one second tab is received within at least one second recess of the container.

In some configurations, the at least one first tab and the at least one second tab each extend towards the first end of the mount plate.

In some configurations, the coupling is configured to urge the container towards the second end of the mount plate when the container is secured to the mount.

In some configurations, the at least one first tab comprises a pair of first tabs spaced-apart from one another along the first end of the mount plate, and the at least one first recess comprises a pair of first recesses.

In some configurations, an outer surface of the container comprises a pair of recesses separated by a ridge, and one of the pair of first recesses is provided in each of the pair of recesses.

In some configurations, the at least one second recess is located on the ridge.

In some configurations, the aperture is defined within the ridge.

In some configurations, the container includes a plug configured to close the aperture when the container is separated from the mount.

In some configurations, the container comprises a plug receptacle configured to receive the plug when the container is secured to the mount.

In some configurations, a leash secures the plug relative to the container.

In some configurations, the container includes an access opening to the interior cargo space, and the access opening is located on a side of the container when the container is secured to the vehicle.

In some configurations, a lid closes the access opening, and the lid opens towards a top of the container.

In some configurations, the container includes a plurality of divots provided in one or more patterns configured to provide drill locations for mounting of one or more accessories to the container.

In some configurations, the cargo container is configured to be removably coupled to a wall, shelving, and/or a pallet rack.

In some configurations, the cargo container further includes one or more mounting slots.

In some configurations, the one or more mounting slots are positioned on a surface of the container opposite an access opening to the interior cargo space.

In some configurations, the one or more mounting slots are configured to receive a portion of a mounting bracket.

In some configurations, the mounting bracket includes a body and a lip portion that extends from the body.

In some configurations, the one or more mounting slots are configured to receive the lip portion of the mounting bracket.

In some configurations, the mounting bracket is configured to be coupled to a mounting surface and configured to removably couple the container to the mounting surface.

In some configurations, a first portion of the container is positioned in a channel formed by the mounting bracket and the mounting surface.

In some configurations, a second portion of the container is configured to contact the mounting surface.

In some configurations, the second portion is positioned below the one or more mounting slots when the container is coupled to the mounting surface.

In some configurations, the mounting surface includes a wall, shelving, and/or a pallet rack.

An aspect of the present disclosure involves a cargo container assembly for a vehicle including a container that defines an interior cargo space. The container includes a wall that defines at least a first aperture and a second aperture. The cargo container assembly includes a first mount and a second mount. Each of the first mount and the second mount is configured to be attached to the vehicle separately from the container. A first coupling is configured to allow the container to be secured to the first mount and a second coupling is configured to allow the container to be secured to the second mount. Each of the first coupling and the second coupling comprises a first portion located on the respective one of the first mount and the second mount and a second portion located on the container. A portion of the first coupling extends through the first aperture and a portion of the second coupling extends through the second aperture when the container is secured to the first mount and the second mount.

In some configurations, the first mount and the second mount are spaced from one another along a length of the container.

In some configurations, the container comprises an access opening to the interior cargo space, and wherein the access opening extends along the length of the container and is located on a side of the container when the container is secured to the vehicle.

In some configurations, a lid closes the access opening, and the lid opens towards a top of the container.

In some configurations, a first seal is configured to create a seal between the first mount and the container along a periphery of the first aperture and a second seal is configured to create a seal between the second mount and the container along a periphery of the second aperture.

In some configurations, the container is secured to the vehicle solely through the first mount and the second mount.

In some configurations, each of the first mount and the second mount comprises at least one first tab at a first end and at least one second tab at a second end, and the at least one first tab is received within at least one first recess of the container and the at least one second tab is received within at least one second recess of the container.

In some configurations, the at least one first tab and the at least one second tab each extends toward the first end of a respective one of the first mount and the second mount.

In some configurations, each of the first coupling and the second coupling is configured to urge the container towards the second end of the first mount and the second mount when the container is secured to the first mount and the second mount.

In some configurations, the at least one first tab comprises a pair of first tabs spaced-apart from one another along the first end of a respective one of the first mount and the second mount, and wherein the at least one first recess comprises a pair of first recesses.

In some configurations, an outer surface of the container comprises a first pair of recesses separated by a first ridge and a second pair of recesses separated by a second ridge, and one of the pair of first recesses are provided in each of the pair of recesses.

In some configurations, the at least one second recess is located on each of a respective one of the first ridge and the second ridge.

In some configurations, the first aperture is defined within the first ridge and the second aperture is defined within the second ridge.

In some configurations, the container comprises a first plug configured to close the first aperture and a second plug configured to close the second aperture when the container is separated from the first mount and the second mount.

In some configurations, the container comprises a first plug receptacle configured to receive the first plug and a second plug receptacle configured to receive the second plug when the container is secured to the first mount and the second mount.

In some configurations, a first leash secures the first plug relative to the container and a second leash secures the second plug relative to the container.

An aspect of the present disclosure involves a system including a rack assembly, at least one mount, and at least one cargo container.

In some configurations, the cargo container includes a side opening.

In some configurations, the cargo container includes a lid that selectively closes the side opening and opens in an upward direction.

An aspect of the present disclosure involves a cargo container than includes

a side opening.

In some configurations, the cargo container is mountable to a roof rack.

In some configurations, the cargo container includes a lid that selectively closes the side opening and opens in an upward direction.

In some configurations, the cargo container is configured to be removably coupled to a wall, shelving, and/or a pallet rack.

In some configurations, the cargo container further includes one or more mounting slots.

In some configurations, the one or more mounting slots are positioned on a surface of the container opposite an access opening to the interior cargo space.

In some configurations, a cargo container assembly, wherein the one or more mounting slots are configured to receive a portion of a mounting bracket.

In some configurations, the mounting bracket includes a body and a lip portion that extends from the body.

In some configurations, the one or more mounting slots are configured to receive the lip portion of the mounting bracket.

In some configurations the mounting bracket is configured to be coupled to a mounting surface and configured to removably couple the container to the mounting surface.

In some configurations, a first portion of the container is positioned in a channel formed by the mounting bracket and the mounting surface.

In some configurations, a second portion of the container is configured to contact the mounting surface.

In some configurations, the second portion is positioned below the one or more mounting slots when the container is coupled to the mounting surface.

In some configurations, the mounting surface includes a wall, shelving, and/or a pallet rack.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a perspective view of a vehicle that incorporates an accessory system having a roof rack assembly and a cargo container assembly.

FIG. 2 is a perspective view of the vehicle and accessory system of FIG. 1 with the nearest cargo container of the cargo container assembly open.

FIG. 3 is a perspective view of the roof rack assembly of FIG. 1 shown separate from the vehicle.

FIG. 4 is a perspective view of a portion of the roof rack assembly of FIG. 3 in an exploded condition.

FIG. 5 is a perspective view of a portion of the roof rack assembly of FIG. 3 showing a clamp that secures a load bar to a side support.

FIG. 6 is a perspective view of a portion of an alternative roof rack assembly in an exploded condition.

FIG. 7 is a perspective view of a mount of the cargo container assembly of FIG. 1.

FIG. 8 is a bottom perspective view of the mount of FIG. 7 shown separated from the cargo container.

FIG. 9 is an enlarged view of a portion of the bottom of the cargo container of FIG. 8.

FIG. 10 is a sectional view of a portion of the cargo container assembled to the mount and a coupling in the form of a latch that couples the cargo container to the mount.

FIG. 11 is a perspective view of an interior of the cargo container showing a plug in a stowed position.

FIG. 12 is a perspective view of the interior of the cargo container showing the plug in an installed position closing an aperture in the cargo container.

FIG. 13 is a perspective view of a top of the cargo container illustrating divots that identify drill points for mounting of additional accessories or accessory mounts to the cargo container.

FIG. 14 is an enlarged view of a portion of the top of the cargo container illustrating a portion of the divots.

FIG. 15 is a perspective view of the vehicle and accessory system of FIG. 1 with additional traction board accessories secured to the cargo containers.

FIG. 16 is a perspective view of the vehicle and accessory system of FIG. 1 with additional fluid container accessories secured to the cargo containers.

FIG. 17 is a perspective view of the cargo container illustrating mounting slots that receive a mounting bracket.

FIG. 18 is a perspective view of a mounting bracket.

FIG. 19 is a partial perspective view of the cargo container with the mounting slots positioned above the mounting bracket.

FIG. 20 is a partial perspective view of the cargo container with mounting brackets inserted into the mounting slots.

FIG. 21 is a perspective view of the cargo container mounted to a structure.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

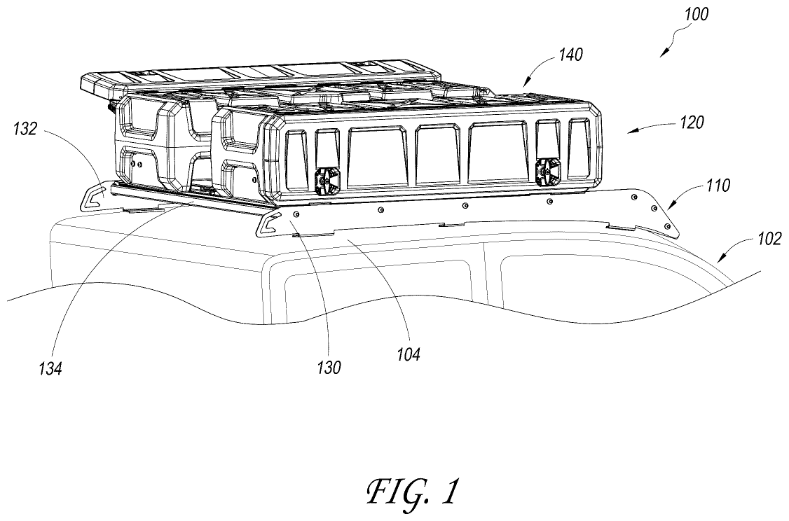

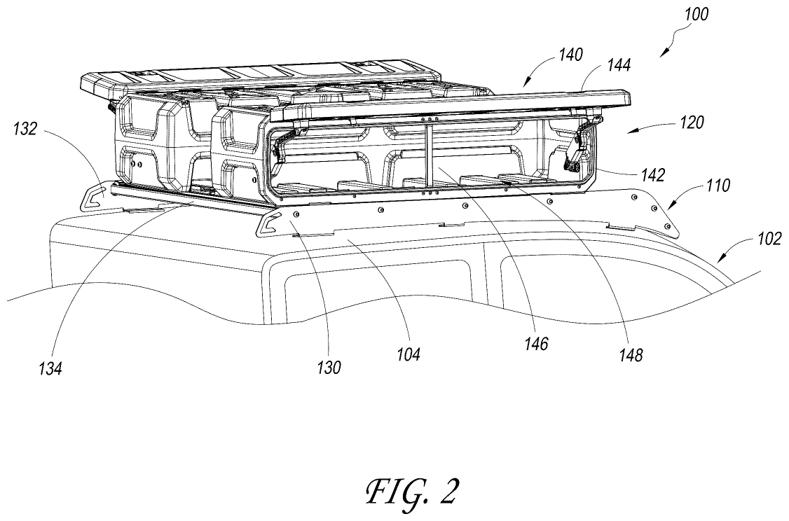

FIGS. 1 and 2 illustrate a vehicle cargo arrangement 100 secured to an associated vehicle 102. The vehicle cargo arrangement 100 is configured to be secured to the vehicle 102 and to facilitate the transport of cargo by the vehicle 102. In the illustrated implementation, the vehicle cargo arrangement 100 is secured or mounted to the roof 104 of the vehicle 102. However, in other implementations, the vehicle cargo arrangement 100 or portions thereof can be mounted to other locations on the vehicle 102, such as to a truck bed rack of a truck or within an interior of a van, for example and without limitation. The description of the vehicle cargo arrangement 100 herein is in the context of a roof-mounted implementation and may be referred to as a “roof rack.” The orientation of the vehicle cargo arrangement 100 and portions thereof assume a roof-mounted implementation in which the vehicle 102 has a generally horizontal roof 104. However, this description is for convenience and is not intended to be limiting because, as discussed above, the vehicle cargo arrangement 100 can be capable of other implementations, which may have non-horizontal orientations.

The vehicle cargo arrangement 100 can be secured or mounted to the vehicle 102 in any suitable manner. For example, the vehicle cargo arrangement 100 can be mounted to dedicated mounting locations on the vehicle 102, such as those used to affix roof rails to the vehicle 102. The vehicle cargo arrangement 100 could also be configured for mounting to existing roof rails of the vehicle 102. The vehicle cargo arrangement 100 could also be configured to mount to the roof 104 of the vehicle 102 that is without dedicated mounting locations or existing roof rails. Such an arrangement could include a plurality of feet that rest on the roof 104 of the vehicle 102 and a plurality of clamps that secure the vehicle cargo arrangement 100 to the vehicle 102. Such a mounting arrangement can be referred to as a “universal” mount, though the arrangement may not be truly universal in application.

The illustrated vehicle cargo arrangement 100 generally includes a rack assembly 110 and one or more cargo container (or “cargo box”) assemblies 120. The rack assembly 110 and the cargo container assembly 120 can be provided and used separately from one another. That is, the rack assembly 110 can be used on its own or with cargo carriers other than the cargo container assembly 120. Similarly, the cargo container assembly 120 can be used with roof racks other than the rack assembly 110, or with other suitable mounting structures.

As illustrated in FIGS. 1 and 2, the rack assembly 110 is secured to the roof 104 of the vehicle 102. The rack assembly 110 can extend along a large portion or a substantial entirety of the roof 104 of the vehicle 102 in a lengthwise direction and/or a widthwise or lateral direction of the vehicle 102. The rack assembly 110 can include a pair of spaced-apart side supports 130, 132 that extend in the lengthwise direction of the vehicle 102. The rack assembly 110 can also include a plurality of cross bars or load bars 134 that extend between the side supports 130, 132 in a lateral direction of the vehicle 102.

A pair of cargo container assemblies 120 are attached to the rack assembly 110 in a side-by-side arrangement. Each of the cargo container assemblies 120 include a cargo container 140 having a container body 142 and a closure or lid 144. The container body 142 defines an interior cargo space 146 and an opening 148 to the interior cargo space 146. In some configurations, the opening 148 to the interior cargo space 146 is located on a side of the container body 142 to facilitate access to the interior cargo space 146. In particular, the opening 148 is outward facing on the vehicle 102. In some configurations, the lid 144 opens in an upward direction towards the top of the container body 142 to further facilitate access to the interior cargo space 146. The illustrated cargo containers 140 are elongated in the lengthwise direction of the vehicle 102. However, other shapes and sizes are also possible.

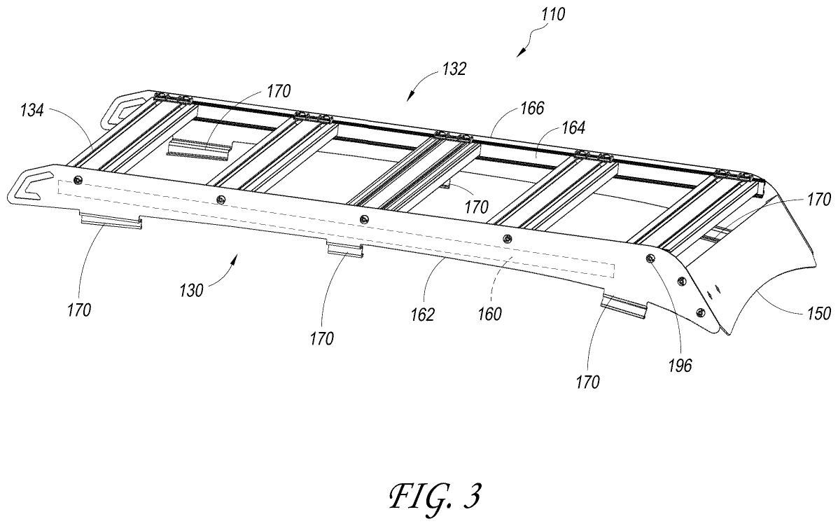

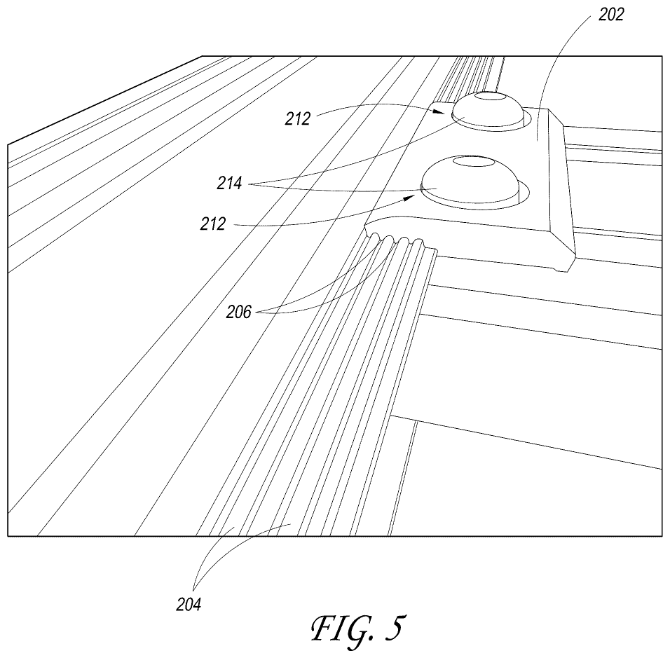

FIGS. 3-6 illustrate a configuration of the rack assembly 110. As described herein, the rack assembly 110 includes the first side support 130 configured to be attached to a first lateral side of the roof 104 of the vehicle 102 and the second side support 132 configured to be attached to a second lateral side of the roof 104 of the vehicle 102 opposite the first side. One or more load bars 134 extend between the first side support 130 and the second side support 132. In the illustrated arrangement, the rack assembly 110 includes a plurality of load bars 134. The illustrated rack assembly 110 includes five load bars 134. However, other numbers of load bars 134 could also be used, such as 2, 3, 4, 6, 7, or more load bars 134.

The illustrated rack assembly 110 includes a front panel or deflector 150 that is located on a forward end of the rack assembly 110 and extends between the first side support 130 and the second side support 132. The deflector 150 can be positioned to deflect at least some of the airflow through a space defined by the side supports 130, 132, the load bars 134, and the roof 104 of the vehicle 102.

In the illustrated arrangement, the first side support 130 includes a first rail 160 and at least one first vertical support in the form of a first side plate 162. The first side plate 162 is configured to support the first rail 160 at an elevated position relative to a corresponding surface of the roof 104 of the vehicle 102. Similarly, the second side support 132 includes a second rail 164 and at least one second vertical support in the form of a second side plate 166. The second side plate 166 is configured to support the second rail 164 at an elevated position relative to a corresponding surface of the roof 104 of the vehicle 102.

Each of the first side plate 162 and the second side plate 166 can be configured for attachment to the vehicle 102. In particular, each of the first side plate 162 and the second side plate 166 includes one or more mounting feet 170 configured to be attached to the vehicle 102, such as to preexisting mounting structures of the vehicle 102. In the illustrated arrangement, each of the first side plate 162 and the second side plate 166 has a plurality of mounting feet 170, including a front mounting foot 170, a rear mounting foot 170 and an intermediate mounting foot 170. The mounting feet 170 can be unitarily formed with the respective one of the first side plate 162 and the second side plate 166.

The first rail 160 of the first side support 130 is configured to support a first end of each of the load bars 134. The first rail 160 includes a first upper wall 180 and a first lower wall 182 that define a first channel 184. The first channel 184 has a first opening 186 that faces the second side support 132 or the centerline of the vehicle 102. The first end of each of the load bars 134 is received within the first channel 184.

The second rail 164 of the second side support 132 is configured to support a second end of each of the load bars 134. The second rail 164 includes a second upper wall 180 and a second lower wall 182 that define a second channel 184. The second channel 184 has a second opening 186 that faces the first side support 130 or the centerline of the vehicle 102. The second end of each of the load bars 134 is received within the second channel 184.

In the illustrated configuration, each of the first rail 160 and the second rail 164 is vertically symmetrical. That is, each of the first rail 160 and the second rail 164 are symmetrical about a horizontal axis passing through a vertical center of the rail 160, 164. Such an arrangement can allow a single structure to be used as both the first rail 160 and the second rail 164 with the second rail 164 being rotated 180° about its longitudinal axis relative to the first rail 160.

The first side plate 162 can be a mirror image of the second side plate 166.

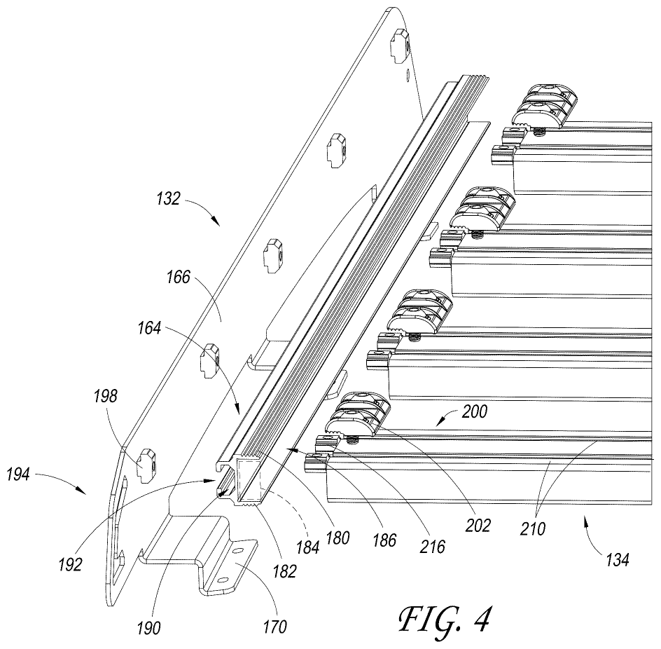

Each of the first rail 160 and the second rail 164 can include a mounting channel 190 that allows the rail 160, 164 to be mounted to the respective side plate 162, 166. In the illustrated arrangement of FIGS. 3 and 4, the mounting channel 190 defines an opening 192 that faces in the opposite direction of the opening 186 or away from a centerline of the vehicle 102.

A mechanical fastener arrangement can attach the first rail 160 to the first side plate 162 and the second rail 164 to the second side plate 166. In the illustrated arrangement, the fastener arrangement includes a plurality of mechanical fasteners 194, each including a bolt 196 (FIG. 3) and a T-nut 198 (FIG. 4). The T-nut 198 is received within the mounting channel 190 of the first rail 160 and the second rail 164. Each of the bolts 196 passes through an opening in the first side plate 162 or the second side plate 166 and engages the T-nut 198 to secure the rail 160, 164 to the respective side plate 162, 166. Other suitable fasteners, fastening structures, or fastening methods can be used to attach the rail 160, 164 to the side plate 162, 166.

As previously described, the opposing ends of each of the load bars 134 are received within the channels 184 of the respective ones of the first rail 160 and the second rail 164. In some configurations, the load bars 134 can be infinitely adjustable along a portion or an entirety of a length of the first rail 160 and the second rail 164. Such an arrangement can allow flexibility in the positioning of the load bars 134 relative to the associated vehicle 102. Such flexibility can allow the load bars 134 to be positioned to avoid interference with structures of the associated vehicle 102, such as a sunroof, moonroof, or antenna, for example.

The load bars 134 can be secured in a desired adjusted position relative to the first rail 160 and the second rail 164. In the illustrated arrangement, a first clamp 200 is associated with the first end of each of the plurality of load bars 134 and secures the first end to the first rail 160 of the first side support 130. A second clamp 200 is associated with the second end of each of the plurality of load bars 134 and secures the second end to the second rail 164 of the second side support 132. In the illustrated arrangement, the first clamp 200 and the second clamp 200 are identical to one another. Furthermore, the clamps 200 of each load bar 134 are identical. Accordingly, only one clamp 200 is described herein. In other arrangements, the clamps on each end of a single load bar 134 or between load bars 134 can vary from one another.

The clamp 200 includes a clamp body 202. The clamp body 202 is secured to the load bar 134 and engages the corresponding rail 160, 164. In particular, the clamp body 202 engages the upper wall 180 of the corresponding rail 160, 164. In the illustrated arrangement, the upper wall 180 of each rail 160, 164 includes a plurality of undulations that define a plurality of grooves 204 that extend along the length of the upper wall 180. The portion of the clamp body 202 that engages the rail 160, 164 includes a plurality of teeth 206 that are configured to mate with the plurality of grooves 204.

The clamp body 202 can be secured to the load bar 134 by any suitable arrangement. In the illustrated arrangement, each of the load bars 134 includes at least one channel 210 that extends in a lengthwise direction of the load bar 134 or in a widthwise direction of the vehicle 102. Accordingly, the at least one channel 210 is perpendicular to or substantially perpendicular to each of the first rail 160 and the second rail 164. In the illustrated arrangement, each load bar 134 includes a pair of channels 210. In the illustrated arrangement, the at least one channel 210 extends the entire length of the load bar 134. However, in alternative arrangements, at least one channel could be provided on each end of each load bar 134.

In the illustrated arrangement, the clamp body 202 is secured to the load bar 134 by one or more fasteners 212. Each fastener 212 includes a bolt 214 and a nut 216. In the illustrated arrangement, a fastener 212 is associated with each of the channels 210 on each end of the load bar 134. Thus, each clamp body 202 is secured to the load bar 134 with a pair of fasteners 212. Each of the channels 210 is configured to receive one of the nuts 216. One of the bolts 214 is engaged with one of the nuts 216 to secure the clamp body 202 relative to the load bar 134.

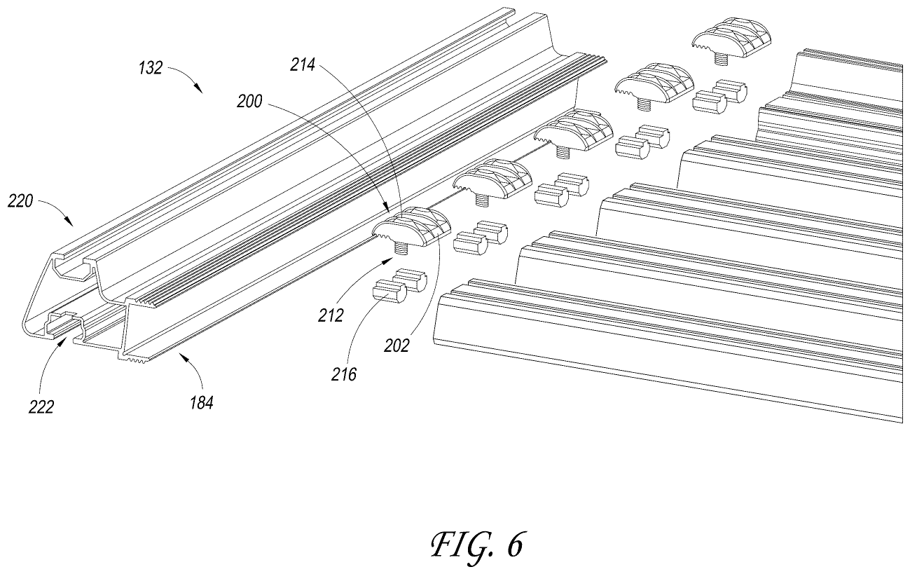

FIG. 6 illustrates a side support 132 that is an alternative version of the side support 132 of FIG. 4. The side support 132 of FIG. 6 can provide the function of the rail 164 or of both the rail 164 and the side plate 166. The side support 132 of FIG. 6 includes the channel 184 configured to receive the load bar 134. The side support 132 of FIG. 6 also includes a first mounting channel 220 and a second mounting channel 222. Each of the mounting channels 220, 222 is similar to or substantially the same as the mounting channel 190 of the rail 164 of FIG. 4. The first mounting channel 220 can be an upward-facing channel and the second mounting channel 222 can be a downward-facing channel. One or both of the first mounting channel 220 and the second mounting channel 222 can be utilized to attach the side support 132 of FIG. 6 directly or indirectly to the vehicle 102.

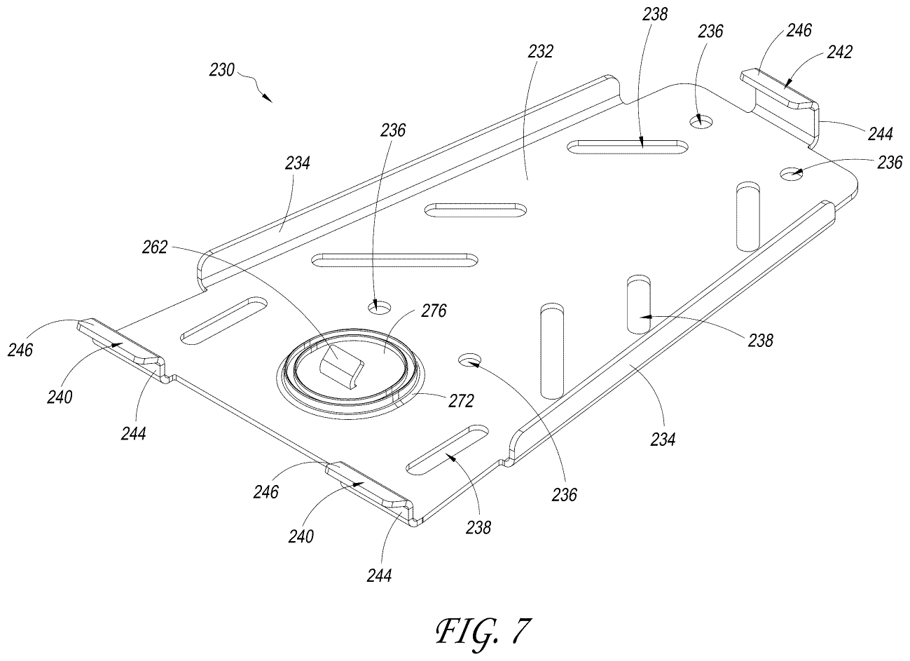

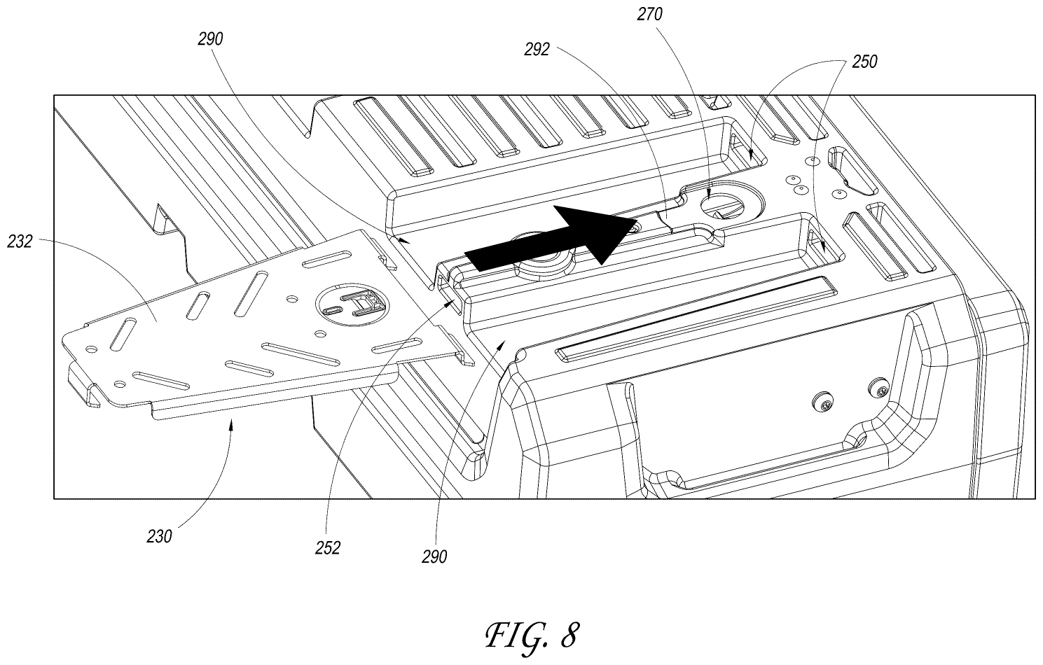

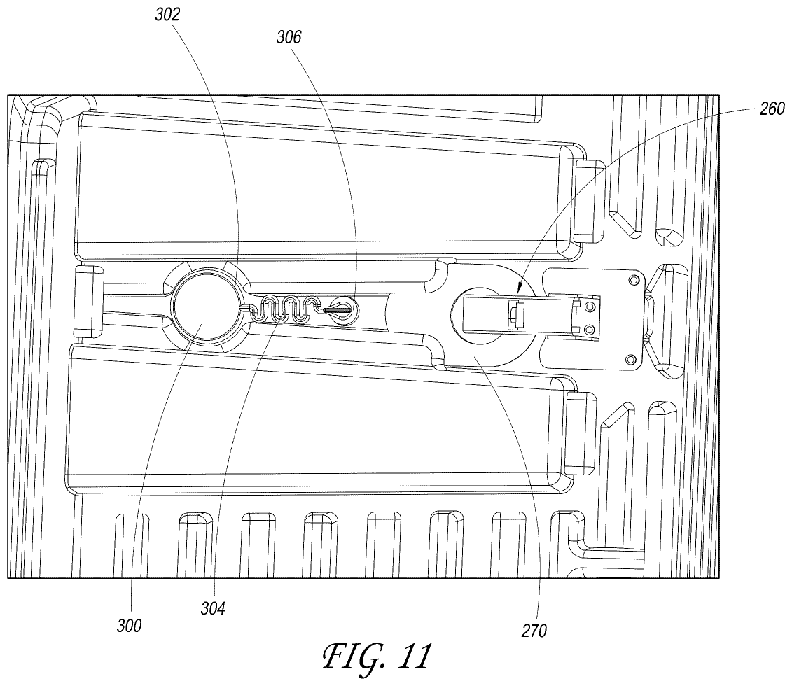

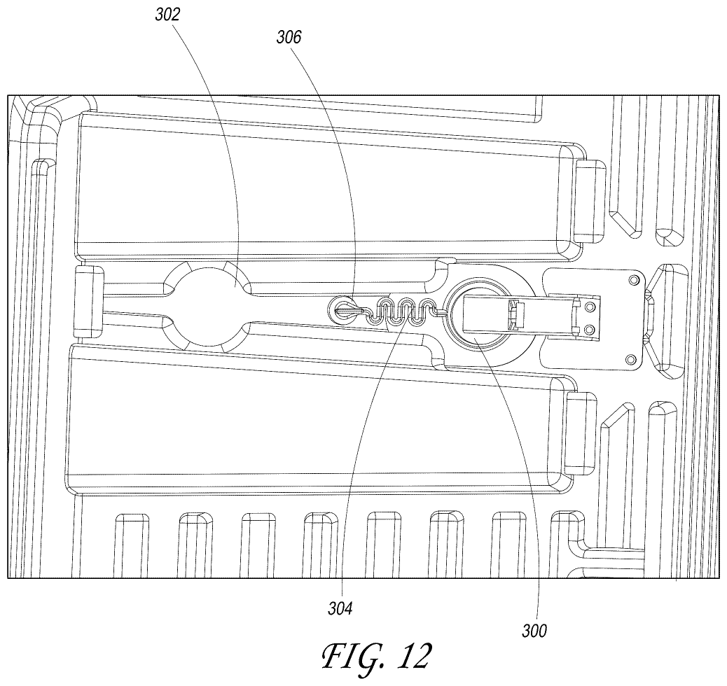

FIGS. 7-16 further illustrate the cargo container assembly 120, which includes a cargo container 140 and one or more mounts 230 configured to secure the cargo container 140 to another object, such as the vehicle 102. In particular, the one or more mounts 230 can be configured for attachment to the rack assembly 110 described herein, to another rack assembly, or to crossbars or other structures of a vehicle. In some configurations, a single cargo container 140 can be secured to the rack assembly 110 by a single mount 230. In some configurations, a single cargo container 140 can be secured to the rack assembly 110 by multiple mounts 230. For example, a single cargo container 140 can be secured to the rack assembly 110 by a pair of mounts 230 spaced along the length (e.g., at a front portion and a rear portion) of the cargo container 140 or by three mounts 230 spaced along the length (e.g., at a front portion, an intermediate portion, and a rear portion) of the cargo container 140. In some configurations, the cargo container 140 is attached to the vehicle 102 or another object solely by the one or more mounts 230. In some configurations, each mount 230 is identical to the others. Accordingly, a single mount 230 is described in detail herein.

In some configurations, the mount 230 includes a mount body in the form of a mounting plate 232. The mounting plate 232 is elongated in a widthwise direction of the cargo container 140 when the mounting plate 232 is attached to the cargo container 140. The illustrated mounting plate 232 includes a strengthening flange 234 extending along each elongated side. The strengthening flanges 234 are upturned or extend towards the cargo container 140 in the illustrated arrangement. The strengthening flanges 234 are perpendicular or substantially perpendicular to the central plate portion of the mounting plate 232.

The illustrated mounting plate 232 includes a plurality of mounting holes 236 and a plurality of slots 238. The mounting holes 236 can be configured to allow the passage of fasteners used to attach the mounting plate 232 to the rack assembly 110 or another structure. The slots 238 can be provided to reduce a weight of the mounting plate 232 but could also be used to allow for the passage of fasteners. The mounting plate 232 can be attached to the rack assembly 110 separately from the cargo container 140. That is, mounting plate 232 can be attached to the rack assembly 110 and the cargo container 140 can be conveniently attached to and removed from the mounting plate 232 while the mounting plate 232 remains attached to the vehicle 102 via the rack assembly 110 or another suitable mounting arrangement.

The mounting plate 232 is configured to engage with the cargo container 140. The mounting plate 232 can include one or more engagement portions configured to engage with corresponding engagement regions of the cargo container 140. In the illustrated arrangement, the mounting plate 232 includes one or more first tabs 240 at a first end and one or more second tabs 242 at a second end of the mounting plate 232. In particular, the illustrated mounting plate 232 includes a pair of first tabs 240 spaced apart from one another along the first end and a single, centrally located second tab 242 on the second end of the mounting plate 232.

Each of the first tabs 240 and the second tab 242 can be unitarily formed with main plate portion of the mounting plate 232 such that the tabs 240, 242 are formed as a single piece with the main plate portion of the mounting plate 232. Each tab 240, 242 includes an upright portion 244 that extends upwardly in a perpendicular or substantially perpendicular direction from the main plate portion of the mounting plate 232. Each tab 240, 242 also includes a return portion or an angled end portion 246 that is angled relative to the upright portion 244. The angled end portion 246 can be oriented at an oblique angle relative to the upright portion 244 and/or to the main plate portion of the mounting plate 232. In other configurations, the angled end portion 246 could be perpendicular or substantially perpendicular to the upright portion 244 or parallel to or substantially parallel to the main plate portion of the mounting plate 232. In the illustrated configuration, the first tabs 240 and the second tab 242 each extend in a direction from the second end towards the first end of the mounting plate 232. In particular, the angled end portions 246 each extend in a direction from the second end towards the first end of the mounting plate 232.

The cargo container 140 can include receptacle structures configured to engage each of the one or more mounts 230 to which the cargo container 140 is configured to be attached. Each set of receptacle structures can be identical to one another. Accordingly, one set of receptacle structures associated with a single mount 230 is disclosed in detail herein. Accordingly, the one or more set of receptacle structures of the cargo container 140 can receive the first tabs 240 and the second tab 242. In the illustrated arrangement, the cargo container 140 includes one or more first recesses 250 configured to receive the one or more first tabs 240 and one or more second recesses 252 configured to receive the one or more second tabs 242. In particular, the illustrated cargo container 140 includes a pair of first recesses 250 and a single second recess 252 centrally located between the pair of first recesses. The pair of first recesses 250 are configured to receive the pair of first tabs 240 and the single second recess 252 are configured to receive the single second tab 242.

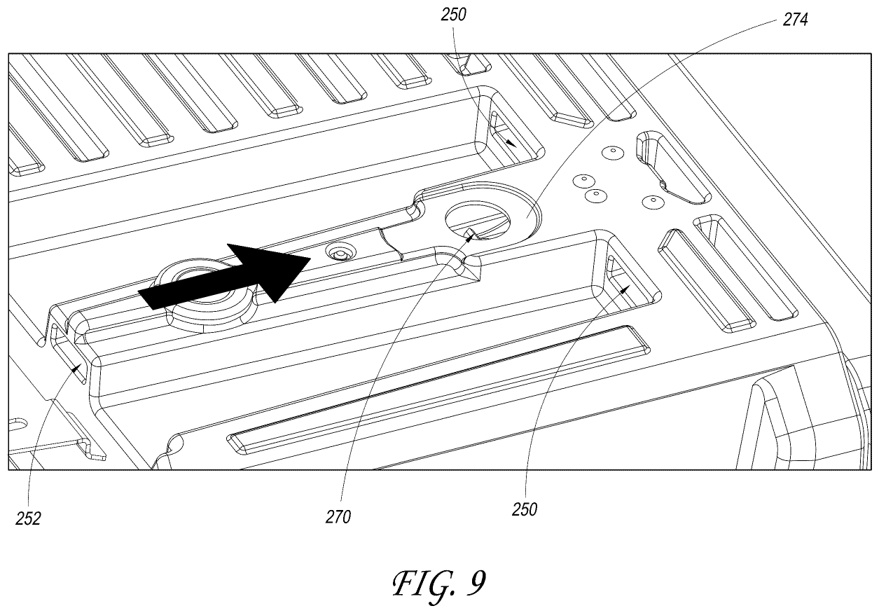

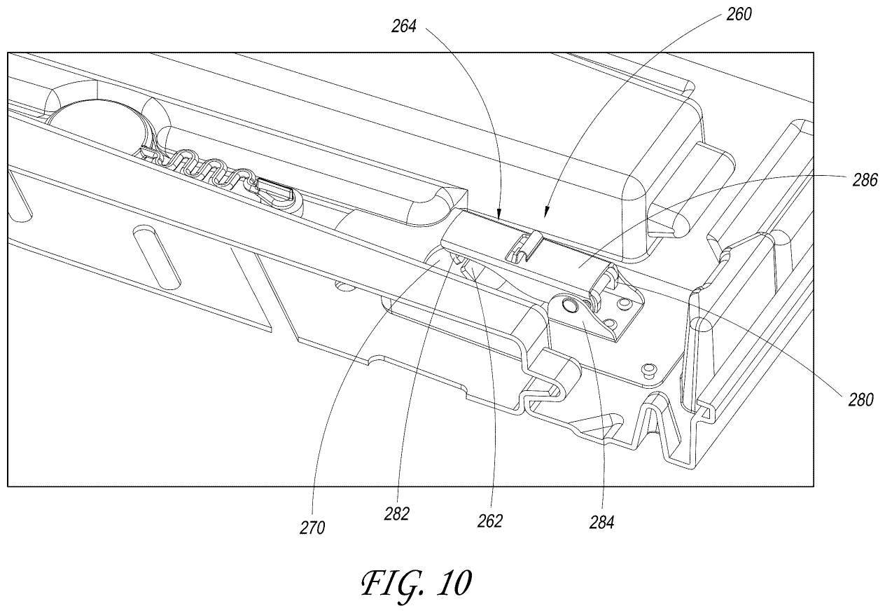

One or more or each of the recesses 250, 252 includes surfaces shaped complementary to the corresponding one of the tabs 240, 242. In particular, one or more or each of the recesses 250, 252 includes an oblique surface configured to interact with the angled end surface 246 of the tabs 240, 242 as a wedge arrangement. The cooperating surfaces can be referred to herein as wedge surfaces. The cargo container 140 is configured to slide onto the tabs 240, 242 of the one or more mounting plates 232 in a direction from the first end to the second end of the mounting plate 232. FIG. 9 illustrates the direction of engagement between the mounting plate 232 and the cargo container 140 from the perspective of the mounting plate 232 moving towards the cargo container 140. However, in use, the mounting plate 232 will usually be stationary and the cargo container 140 will move in the opposite direction towards the mounting plate 232. As illustrated in FIG. 10, the wedge arrangement interaction between the tabs 240, 242 and the recesses 250, 252 results in a tight and secure engagement of the cargo container 140 onto the mounting plate(s) 232 with the cargo container 140 fully engaged with the mounting plate(s) 232.

The cargo container assembly 120 includes one or more couplings or other securement structures to secure the cargo container 140 in the fully engaged position on the mounting plate(s) 232. In the illustrated arrangement, the coupling is a latch assembly or latch 260. Furthermore, in the illustrated arrangement, a single coupling or latch 260 secures the cargo container 140 in the engaged position relative to each of the one or more mounting plates 232. The single latch 260 is used in combination with the tabs 240, 242 and recesses 250, 252. However, in other arrangements, more than one coupling or latch 260 could be used, alone or in combination with the tabs 240, 242 and recesses 250, 252. The latch 260 can be configured to urge the cargo container 140 towards or to the fully engaged position relative to the mounting plate 232. In particular, the direction of action of the latch 260 can tend to move the cargo container 140 towards or to the fully engaged position relative to the mounting plate 232.

In some configurations, at least a portion of the latch 260 is located within the interior space 146 of the cargo container 140. In the illustrated arrangement, a first portion 262 of the latch 260 is located on the mount 230 or mounting plate 232 and a second portion 264 of the latch 260 is located on or otherwise carried by the cargo container 140. A wall (e.g., a bottom wall) of the cargo container 140 defines an aperture 270 through which a portion of the latch 260 extends or can pass when the cargo container 140 is secured to the mounting plate 232. In the illustrated arrangement, the first portion 262 of the latch 260 is or comprises a catch and the second portion 264 of the latch 260 is or comprises a remainder of the latch 260.

The mounting plate 232 includes the catch 262, at least a portion of which passes from outside the cargo container 140 to the interior space 146 through the aperture 270 when the cargo container 140 is attached to the mounting plate 232. In the illustrated arrangement, the catch 262 is located on a raised portion 272 of the mounting plate 232, which is raised relative to a surrounding portion of the mounting plate 232 and/or a main plate portion of the mounting plate 232. The illustrated raised portion 272 is circular but other shapes could be provided. The raised portion 272 is received within a complementary (e.g., circular) recess 274 of the cargo container 140 that surrounds the aperture 270. However, in other arrangements, an entirety of the raised portion 272 could engage or extend through the aperture 270.

A seal 276 surrounds the catch 262 and covers a portion or an entirety of the raised portion 272. The seal 276 is configured to engage a surface of the recess 274 of the cargo container 140 that surrounds the aperture 270. With such an arrangement, the seal 276 creates at least a partial seal or a substantially complete seal between the mounting plate 232 of the mount 230 and the cargo container 140 around a periphery of the aperture 270 to inhibit or prevent the passage of liquid or other undesired substances into (or out of) the interior space 146 of the cargo container 140 through the aperture 270. In other arrangements, the seal 276 could be carried by the cargo container 140 instead of the mounting plate 232. Or, a seal could be provided on each of the mounting plate 232 and the container 140.

As described above, the first portion 262 of the latch 260 is or comprises the catch 262 and the second portion 264 of the latch 260 is or comprises a remainder of the latch 260. The remainder of the latch 260 can be a draw latch, toggle latch, or similar type latch that includes a latch arm 280 having an engagement portion 282 (e.g., a claw or hook) that selectively engages the catch 262 to secure the first portion 262 to the second portion 264. The latch arm 280 can be attached in an over-center manner to an anchor plate 284 by a lever 286. The lever 286 is configured to actuate the latch arm 280. Other suitable types of latches could also be used.

In the illustrated arrangement, an outer surface (e.g., a bottom surface) of the cargo container 140 comprises a pair of elongated recessed portions or recesses 290 that extend in a widthwise direction of the cargo container 140. The pair of recesses 290 are separated by a ridge 292. A surface of the ridge 292, which contains the aperture 270, can lie within a plane with the bottom surface of the cargo container 140. The pair of recesses 290 and the ridge 292 are associated with each location configured to interact with the mounting plate 232 of the mount 230. The ridge 292 contains the second recess 252. The recesses 290 have open ends located adjacent the second recess 252 and closed ends that contain the first recesses 250.

In some configurations, the cargo container 140 includes a plug 300 configured to close the aperture 270 when the cargo container 140 is separated from the mount 230. The illustrated plug 300 is of the same shape (e.g., circular) as the aperture 270. The cargo container 140 can include a plug receptacle 302 configured to receive the plug 300 when the cargo container 140 is secured to the mount 230 and the plug 300 is not needed to close the aperture 270. In the illustrated arrangement, a leash 304 secures the plug 300 relative to the cargo container 140. The leash 304 has an end that is secured to the cargo container 140, such as with an interference fit in a boss 306 of the cargo container 140. The illustrated leash 304 has a serpentine shape, which allows the leash 304 to be elongated from its formed serpentine shape.

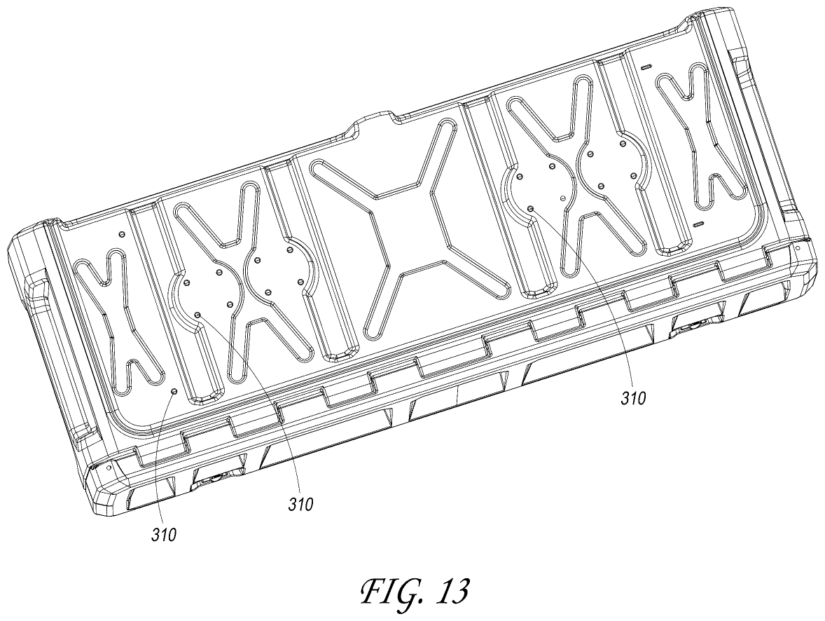

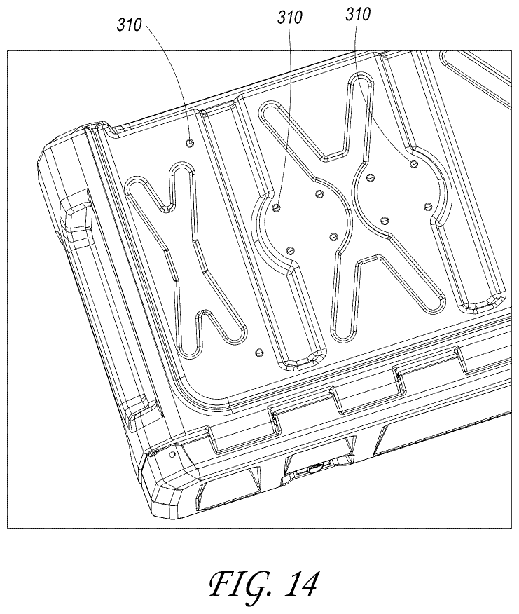

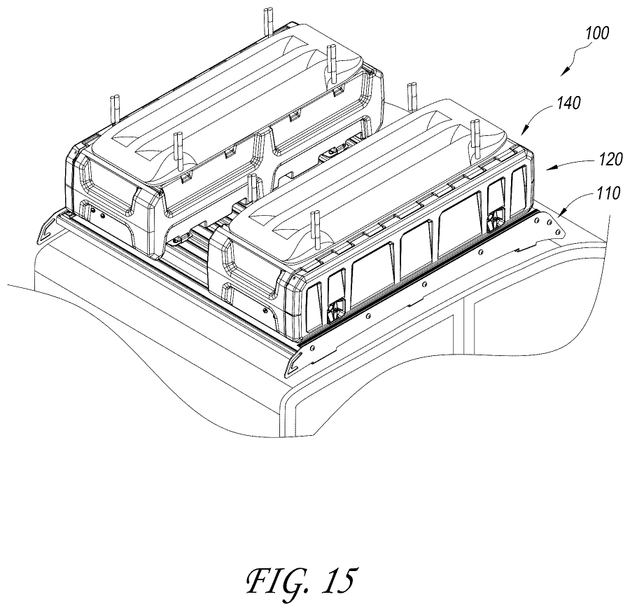

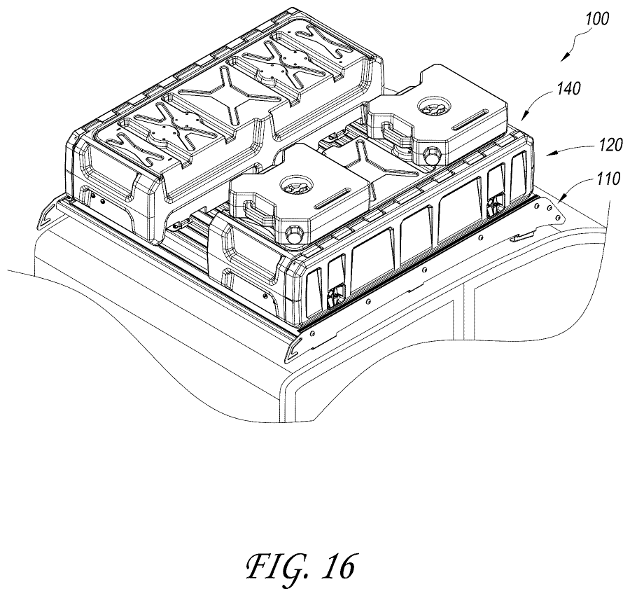

In some configurations, the cargo container 140 includes a plurality of divots 310 provided in one or more patterns configured to provide drill locations for mounting of one or more accessories to the cargo container 140. FIGS. 13 and 14 illustrate the divots 310. FIGS. 15 and 16 illustrate accessories mounted to the tops of the cargo containers 140 using mounts secured to the cargo container 140 through holes drilled at the locations of one or more divots 310. The divots 310 can be provided in patterns suitable for the mounting arrangements or mounts for common or desired accessories, such as traction boards (FIG. 15) or fluid (e.g., water or fuel) containers (FIG. 16).

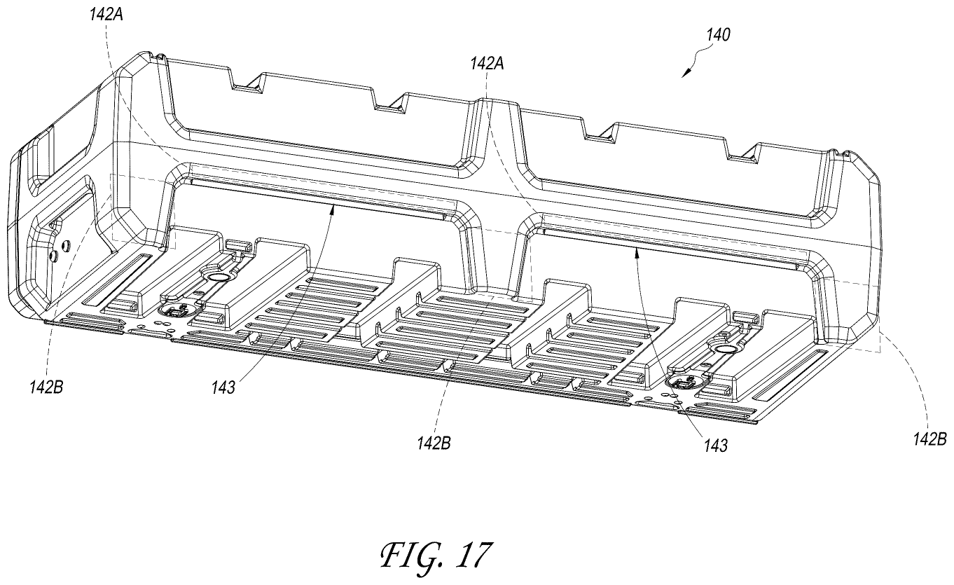

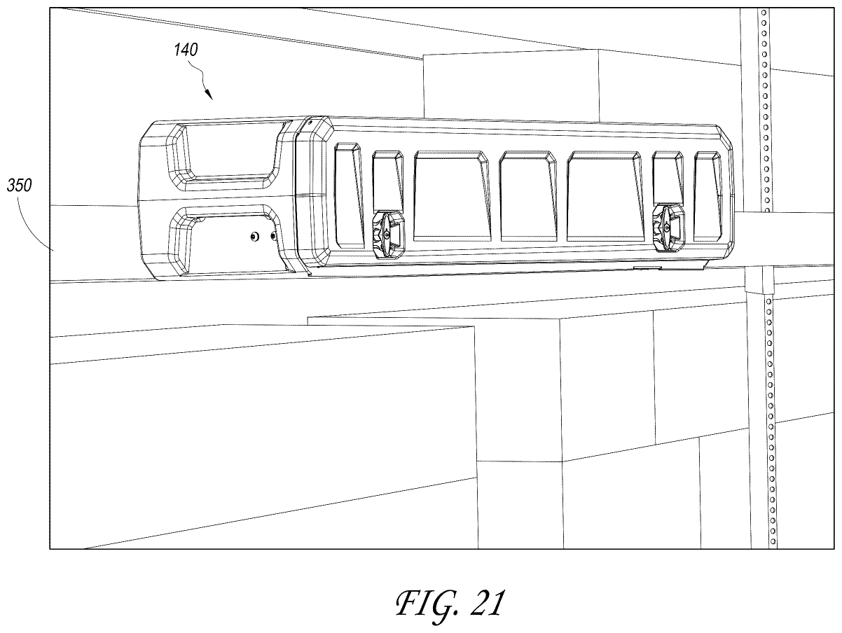

FIGS. 17-21 further illustrate the cargo container 140 and mounting brackets 400. As shown in FIG. 17, the container body 142 can include mounting slots 143. The mounting slots 143 can include a recess in the container body 142 configured to receive the mounting brackets 400. The mounting slots 143 can be positioned on a back of the container body 142 opposite the opening 148. In some configurations, the container body 142 can include one (1) mounting slot 143, two (2) mounting slots 143, three (3) mounting slots 143, or four (4) mounting slots 143. In some configurations, the container body can include more than four (4) mounting slots 143.

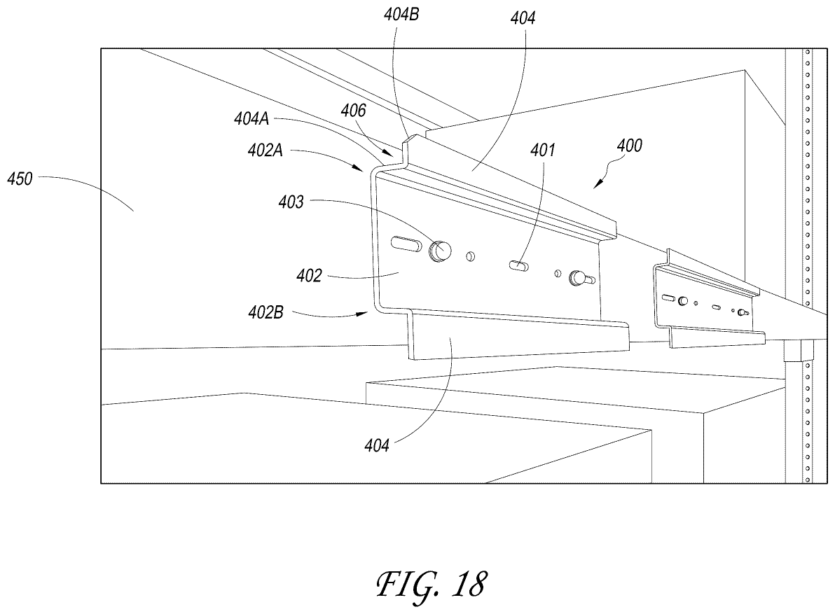

As shown in FIG. 18, each of the mounting bracket 400 includes a body 402 and a lip portion 404. The body 402 includes one or more holes 401 configured to receive a fastener 403. The mounting bracket 400 can be positioned so the body 402 contacts a mounting surface 450 and one or more fasteners 403 can be inserted through the one or more holes 401 to couple the mounting bracket 400 to the mounting surface 450. The mounting bracket 400 can be coupled to the mounting surface 450 so the mounting bracket 400 aligns with an associated one of the mounting slots 143 of the container body 142. The mounting surface 450 can include a wall, shelving, a pallet rack, or a surface of any other structure. Typically, the mounting surface 450 is vertically-oriented. However, it is possible for the mounting surface 450 to be angled or horizontal.

The lip portion 404 can include a first portion 404A and a second portion 404B. The lip portion 404 of the mounting bracket 400 extends from a top end 402A and/or a bottom end 402B of the body 402. A first end of the first portion 404A of the lip portion 404 is coupled to the body 402. The first portion 404A can extend from the body 402 such that when the mounting bracket 400 is coupled to the mounting surface 450, the first portion 404A extends away from the mounting surface 450. The second portion 404B extends from a second end of the first portion 404A opposite the first end of the first portion 404A. The second portion 404B can extend from the second end of the first portion 404A so the second portion 404B extends away from the body 402 in a direction parallel to or substantially parallel to the mounting surface 450. Accordingly, the lip portion 404 and/or the mounting surface 450 form a channel 406.

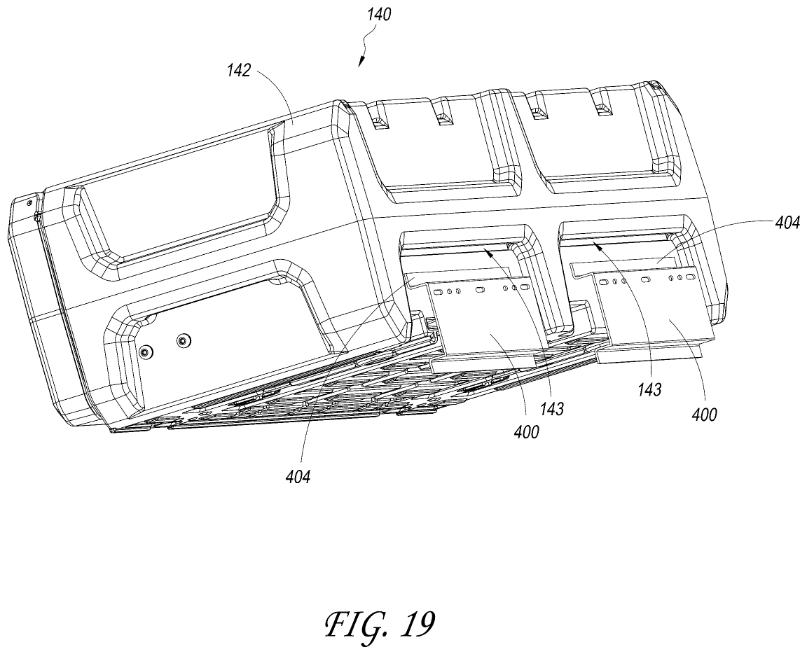

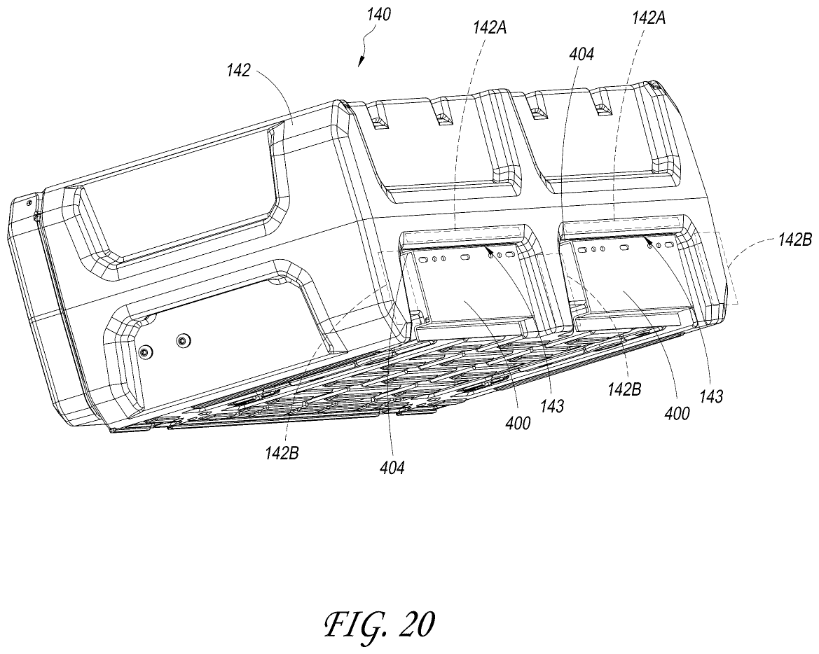

As shown in FIGS. 19 and 20, the lip portion 404 of the mounting bracket 400 is configured to be inserted into the mounting slots 143 of the container body 142. When the mounting bracket 400 is coupled to the mounting surface 450, the cargo container 140 can be positioned above the mounting brackets 400 so the lip portion 404 aligns with the mounting slots 143, as shown in FIG. 19. The cargo container 140 can be lowered so the lip portion 404 of the mounting brackets 400 are inserted into the mounting slots 143. Accordingly, a portion 142A of the container body 142 may be positioned in the channel 406 formed by the lip portion 404 and/or the mounting surface 450 to secure the container 140 to the mounting bracket 400 and/or the mounting surface 450. In some configurations, a second portion 142B of the container body 142 located below the mounting slots 143 can contact the mounting surface 450 to prevent or inhibit rotation of the container 140 around an axis along the length of the container 140.

### CONCLUSION

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

1. A rack assembly for a vehicle, comprising:
a first side support configured to be attached to a first lateral side of the vehicle, the first side support having a first upper wall and a first lower wall defining a first channel having a first opening;
a second side support configured to be attached to a second lateral side of the vehicle opposite the first side, the second side support having a second upper wall and a second lower wall defining a second channel having a second opening, wherein the first opening faces the second side support and the second opening faces the first side support;
a plurality of load bars that extend between the first side support and the second side support, each of the plurality of load bars having a first end and a second end, wherein the first end of each of the plurality of load bars is received within the first channel and the second end of each of the plurality of load bars is received within the second channel;
a first clamp associated with the first end of each of the plurality of load bars, wherein the first clamp secures the first end to the first side support; and
a second clamp associated with the second end of each of the plurality of load bars, wherein the second clamp secures the second end to the second side support.

2. (canceled)

3. (canceled)

4. (canceled)

5. (canceled)

6. The rack assembly of claim 1, wherein each of the plurality of load bars is infinitely adjustable between a first end and a second end of each of the first channel and the second channel.

7. The rack assembly of claim 1, wherein the first side support comprises a first rail and at least one first vertical support configured to support the first rail at an elevated position relative to a corresponding surface of the vehicle, and wherein the second side support comprises a second rail and at least one second vertical support configured to support the second rail at an elevated position relative to the corresponding surface of the vehicle.

8. (canceled)

9. (canceled)

10. (canceled)

11. The rack assembly of claim 1, further comprising a container supported by the plurality of load bars.

12. (canceled)

13. The rack assembly of claim 11, further comprising a mounting plate that is attached to one or more of the plurality of load bars, wherein the container is attached to the mounting plate.

14. (canceled)

15. (canceled)

16. A cargo container assembly for a vehicle, comprising:
a container that defines an interior cargo space, the container comprising a wall that defines an aperture;
a mount configured to be attached to the vehicle separately from the container;
a coupling configured to allow the container to be secured to the mount, wherein the coupling comprises a first portion located on the mount and a second portion located on the container, wherein a portion of the coupling extends through the aperture when the container is secured to the mount.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A cargo container assembly for a vehicle, comprising:
a container that defines an interior cargo space, the container comprising a wall that defines at least a first aperture and a second aperture;
a first mount and a second mount, each of the first mount and the second mount configured to be attached to the vehicle separately from the container;
a first coupling configured to allow the container to be secured to the first mount and a second coupling configured to allow the container to be secured to the second mount, wherein each of the first coupling and the second coupling comprises a first portion located on the respective one of the first mount and the second mount and a second portion located on the container, wherein a portion of the first coupling extends through the first aperture and a portion of the second coupling extends through the second aperture when the container is secured to the first mount and the second mount.

38. The cargo container assembly of claim 37, wherein the first mount and the second mount are spaced from one another along a length of the container.

39. (canceled)

40. (canceled)

41. The cargo container assembly of claim 37, further comprising a first seal configured to create a seal between the first mount and the container along a periphery of the first aperture and a second seal configured to create a seal between the second mount and the container along a periphery of the second aperture.

42. The cargo container assembly of claim 37, wherein the container is secured to the vehicle solely through the first mount and the second mount.

43. The cargo container assembly of claim 37, wherein each of the first mount and the second mount comprises at least one first tab at a first end and at least one second tab at a second end, wherein the at least one first tab is received within at least one first recess of the container and the at least one second tab is received within at least one second recess of the container.

44. (canceled)

45. (canceled)

46. (canceled)

47. (canceled)

48. (canceled)

49. (canceled)

50. The cargo container assembly of claim 37, wherein the container comprises a first plug configured to close the first aperture and a second plug configured to close the second aperture when the container is separated from the first mount and the second mount.

51. (canceled)

52. (canceled)

53. (canceled)

54. The cargo container assembly of claim 16, wherein the container further comprises one or more mounting slots.

55. (canceled)

56. The cargo container assembly of claim 54, wherein the one or more mounting slots are configured to receive a portion of a mounting bracket.

57. The cargo container assembly of claim 56, wherein the mounting bracket comprises a body and a lip portion that extends from the body.

58. The cargo container assembly of claim 57, wherein the one or more mounting slots are configured to receive the lip portion of the mounting bracket.

59. The cargo container assembly of claim 56, wherein the mounting bracket is configured to be coupled to a mounting surface and configured to removably couple the container to the mounting surface.

60. The cargo container assembly of claim 59, wherein a first portion of the container is positioned in a channel formed by the mounting bracket and the mounting surface.

61. The cargo container assembly of claim 60, wherein a second portion of the container is configured to contact the mounting surface.

62. The cargo container assembly of claim 61, wherein the second portion is positioned below the one or more mounting slots when the container is coupled to the mounting surface.

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)
